(19) United States
(12) Patent Application Publication
(10) Pub. No.: US 2004/0180143 A1
(43) Pub. Date: Sep. 16, 2004

(54) Paint ball gun having permanent lubricated surfaces

(76) Inventors: Jonathan G. Gilbertson, Bloomington, MN (US); Stephen M. Gilbertson, Bloomington, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/799,249

(22) Filed: Mar. 12, 2004

Related U.S. Application Data
(60) Provisional application No. 60/453,990, filed on Mar. 12, 2003.

(51) Int. Cl. B05D 5/00

(52) U.S. Cl. 427/256; 427/421.1

(57) ABSTRACT

The performance of a paint ball marker is improved by applying a permanent lubricating agent to selected working parts of the marker in place of petroleum-based lubricants using known processes for applying metals, ceramics, graphite and various polymers to such working parts.

### BACKGROUND OF THE INVENTION

I. Field of the Invention:

This invention relates to paint ball markers used to primarily fire gelatin capsules containing a marking colorant, and more particularly to a method or process for treating paint ball markers to provide permanent lubrication and/or increased hardness to those parts of the marker subjected to friction, wear, corrosion and/or contamination.

II. Discussion of the Prior Art:

In recent years, paint ball markers and games have become popular. The typical area to play this game is in large open spaces with scattered coverage. Persons participating in this extreme sport wear protective clothing and goggles to prevent injury as players fire paint-filled gelatin balls from a device called a marker, especially made to fire this projectile. A single source of compressed gas provides the energy for driving multiple gelatin capsules filled with liquid called paint. Thousands of paint balls can be fired by a marker in a single game. The gelatin capsule is propelled out of the marker's barrel with a typical muzzle velocity of 300 feet-per-second or less. When the paint ball strikes an object or another player, the gelatin shell fractures, leaving a brightly colored splatter on the object or player.

With most existing paint ball markers, after several rounds are fired, it is necessary to disassemble the marker, clean the barrel to remove contamination and lubricate the moving parts to prevent damage to the marker.

Contamination can damage the marker and degrade it's performance. If contamination becomes present in the marker it is a serious issue. Contamination in the marker is a consequence of many factors. Most of these contaminants are a result of current marker designs, the materials used to construct the marker and the environment in which the games are played. One such contaminant is dirt. Dirt generally comes from the environment in which the game is played. Another contaminant is material debris. Debris comes from the sheering and/or scoring of the metal or plastic inside the marker. Another is moisture and ice. Ice is formed when the gas in the tank expands and freezes the atmospheric moisture. Another contaminate is gelatin. Gelatin is the substance, which makes up the outer shell of the paint ball. Gelatin is soft and will adhere or build up in the marker. As the paint ball travels through the marker it will deposit gelatin and become lopsided. With the build up of gelatin in the marker, the paint ball may be squeezed as it travels through the barrel of the marker. Both of these conditions can lead to premature paint ball breakage and inaccurate shots. Contamination and improper lubrication will also create unwanted friction. This friction occurs when the marker's moving parts contact one another. This causes multiple problems for the marker. Such problems include deteriorating tolerances, excessive wear on metals, rubber, and plastics in the marker, increased scoring, and increased friction. These conditions tend to cause the ball speed to decrease and gas usage to increase.

O-rings play a significant role in the operation of paint ball markers. The o-rings seal the path in which the compressed gas travels, which in turn moves the operating mechanisms and propels the paint ball. O-rings can be compromised due to lack of lubrication and/or contamination. The result is a decrease in gas efficiencies from gas blow-by and an increase in the marker's wear. The O-rings can also fail when the marker is improperly lubricated and scoring of the metal occurs. Scoring produces sharp edges that cut and destroy the o-ring. Such events mandate the marker be disassembled and inspected. If any damage is found, one must then replace all worn parts, clean contaminated parts and lubricate the marker before it can again be used.

Lubricating a paint ball marker is a tedious and time-consuming process. First, one must take the marker apart, degrease it, clean it, lubricate it with oil or grease and then reassemble it. Petroleum-based lubricants, i.e., oils and greases, currently used in maintaining paint ball markers are inadequate because they lead to scoring and must be reapplied after cleaning and/or after a short term of use. The main purpose of a lubricant is to coat and create a seal or boundary on the moving parts. Current petroleum-based lubricants fail for several reasons. 1) The typical paint ball lubricant is not designed to provide the necessary protection against the extreme pressures and cold caused from the compressed gasses in the marker. 2) Another problem is that the air movement forces the oil or grease lubricant away from the moving parts leaving inadequate amounts of lubricant in place which then result in an increase in friction. 3) The lubricant oil/grease can become contaminated, rendering it ineffective. For example, dirt, metal shavings, ice or moisture tend to displace and contaminate the lubrication. Oil and grease will hold these contaminants. The contaminants, in turn, rub on the marker's surfaces, causing scoring and wear. 4) The amount of lubricant applied might also be inadequate, leaving materials in the marker that significantly increase friction that can lead to failure. 5) Current petroleum-based lubricants are not able to provide adequate lubricity in the extreme cold associated with markers. Thus, it is imperative paint ball markers be frequently cleaned and lubricated.

From the foregoing, it can be seen that it would be highly advantageous if a paint ball marker could be relatively permanently lubricated by a medium other than the oil/grease lubricants currently used, allowing the marker to operate more efficiently and over extended periods of time. Solid non-petroleum-based lubricants can provide effective lubrication to maintain factory tolerances, thereby creating a more efficient marker. In addition, it would be advantageous if the metals are hardened to increase the metal''s strength. This would also help reduce wear and scoring and would keep the marker in factory specifications.

It is accordingly a principal object of the present invention to eliminate the foregoing problems of paint ball markers as well as the need for oil and grease lubricants by applying a solid lubricious material to those areas of the paint ball marker that would encounter friction, oxidation or corrosion during its use and, if needed, to harden the metals to prevent sheering and scoring of the moving parts. Such solid lubrication, when done as taught herein, tends to be long lasting when compared to petroleum-based lubricants and eliminates most, if not all, of the lubrication problems currently associated with paint ball markers.

There have been coatings developed for the firearm industry to help prevent corrosion of metal parts exposed to products of combustion of gunpowder. All of those coating have been developed to counteract two main problems. First, the corrosiveness of the chemicals used to create the combustion which propels the bullet, and, second the extreme heat in the barrel caused by the explosion inside the shell and friction of that bullet in the barrel.

U.S. Pat. No. 6,090,756 to Brown addresses the need to place a conditioning coating on the moving parts and the barrel bore of rifles, shot guns and other firearms. This coating is used to primarily prevent corrosion. This is only placed where gunpowder residue may contact the firearm. i.e. the barrel, shell, cartridge, and chambers.

In today's paint ball markers, the problems associated with firearms do not exist. In fact, the problems of the paint ball marker are exactly opposite of those of firearms. A firearm must constantly contend with extreme heat. The paint ball marker constantly deals with the opposite-extreme cold. A marker can become so cold that petroleum-based lubricants will stop functioning and the marker will no longer work. This cold comes from the release of the compressed gas, usually CO₂, stored in a tank attached to the marker. The firearm uses gunpowder in the shells that propel the bullets. This chemical propellant can be corrosive to steel, can leave contamination and often causes significant unwanted heat upon firing the weapon. The paint ball marker, on the other hand, uses compressed gas, which leaves little or no chemical contamination. In firearms, contact of the bullet and the barrel causes friction, producing heat. This does not occur in the paint ball marker because the gelatin does not cause significant friction in the barrel, and the barrel is constantly cooled by the expanding gas.

Firearms are generally made from steel. Paint ball markers use aluminum as the main base metal. Aluminum is the material of choice in markers because of low cost, it is easily machined, it is light in weight, and is adequate to handle the pressures involving the compressed gases used to drive the marker. If a firearm were to be completely made out of aluminum of the type currently used in paint ball markers, that aluminum would be incapable of handling the heat and pressures involved with the explosion that occurs from the firearm's shell. Another difference is that in lubricating a firearm, one typically only coats the interior of the barrel with an oil to inhibit rusting. There is no need to coat the entire firearm to increase its efficiency, as there is ample energy in each shell to drive the mechanisms in the gun. Stated otherwise, it is not critical to reduce friction since there is an abundance of energy from the explosion of the shell or cartridge to cycle the firearm.

In paint ball markers, it is crucial to use the least amount of gas possible as this allows one to keep paint ball speed close to the maximum 300 feet per second. It also will allow one to use lower gas pressure in the marker. Lower gas pressure is significant in maintaining paint ball accuracy. One reason for reducing friction is to increase gas efficiency, since a marker has a limited amount of gas storage. This gas operates the marker and propels the paint ball. As the gas pressure decreases, the speed of the paint ball accordingly decreases. The less gas used with each shot, the more gas left in storage for the following shots. This allows the marker to cycle faster. It also allows the paint ball speed to remain closer to the peak speed of 300 feet per second. With a firearm, to increase the speed of a bullet, within limits, one simply adds more chemical (gun powder) to each individual shell.

### SUMMARY OF THE INVENTION

In accordance with the present invention, relatively permanent lubrication of operating parts of the paint ball marker comprises one or more of hardening selected parts, applying a solid lubricious material to selected parts by adhering, inserting, plating, embedding or impregnating a metal, chemical compound element polymer and a ceramic onto and/or into all surfaces of the paint ball marker and its parts, where contact and relative motion occurs and strengthens the marker or its surfaces to create a stronger substrate, which the lubricant adheres to or is bound with. This would include covering and/or making the entire part out of metals, chemicals, polymers or ceramics that reduce friction, increase chemical resistance, reduce wear, increase hardness and increase lubricity. Thus, metals, such as nickel, silver, steel, zinc, cobalt, titanium, copper, gold, molybdenum, magnesium etc., can be applied as a permanent lubricant as long as they provide any of the following: Reduce friction, increase chemical resistance, reduce wear, increase hardness and increase lubricity; Non-metals, such as Teflon®, graphite, phosphorous, carbon, sulfur, any number of polymers or a suitable ceramic, can also be applied as solid, greaseless lubricants. Said lubricants of the type described are able to withstand loads in excess of 250,000 psi and are capable of lubricating over a wide range of temperatures, where conventional greases and oils are rendered ineffective.

As used herein, “lubricants” consist of any coated or solid material that would reduce friction and/or prevent corrosion and oxidation in or on the moving parts of the paint ball marker and may be coated, adhered, inserted, overlaid, plated, embedded or impregnated in or on the marker for prolonged periods of use. Specifically excluded as a paint ball gun lubricant, as used herein, are oils and greases. The solid lubricants contemplated by the present invention cover the metal surface to fill in rough areas caused by machining, extruding or casting. They protect those rough edges from coming in contact with each other and with the paint ball projectile. These lubricants can also be dry so that dirt and other contaminants do not mix or adhere with the lubricants. These lubricating materials, while not entirely permanent, function to provide a lubricious interface for a significantly time than do most greases and oils heretofore used. When materials are permanently or semi-permanently bonded, embedded or fused to the marker and its parts, the solid lubricant is smoother, harder, slicker, stronger and more lubricious than most oils/greases, therefore, causing less friction fore extended periods. This prevents marker freeze, material wear, jamming from contamination, parts failure, premature rupture of the paint ball projectile and damage to the marker.

By hardening the metals comprising the paint ball gun assembly and/or by adding solid lubricant to the paint ball marker and its parts, the following beneficial results can be realized:

1. The performance of the marker is improved, producing more shots per minute and paint balls that travel farther;

2. The gas efficiency of the marker is improved because the moving parts operate faster, smoother and in conjunction with each other resulting in less gas being used, also the gas pressure can be lowered;

3. Improved accuracy of the marker with less friction between the paint ball and the barrel, so the paint ball will not rupture or deform as it travels through the barrel;

4. With the consistent presence of the lubricant on the moving parts, there is a corresponding decrease in the number of malfunctions encountered;

5. The marker becomes self-cleaning. Because the barrel is more permanently lubricated, if a paint ball should happen to rupture within the barrel, the contaminants can be removed easily. Specifically, the next projectile fired may clear the residue, eliminating the need to squeegee the barrel;

6. The design tolerances of the marker can be improved, resulting in an improved seal on the o-rings, which will, in turn, result in less gas consumption.

7. Greatly decreases the maintenance associated with the marker.

8. With reduced friction, the original tolerances will be maintained for a longer period of time. Scoring of the paint ball projectile will be greatly reduced.

In all of our testing, we have been able to increase the gas efficiency of markers. In the best and most expensive markers non-commercially available, we were able to increase the gas efficiency by at least 10%. On the inexpensive markers, we were able to increase the efficiency by 100%. We were also able to increase the speed (number of balls shot per second) in the best markers by 10%. In addition, we were able to significantly decrease the wear of all the components of the markers.

### DESCRIPTION OF THE DRAWING

FIG. 1 is an exploded view of a typical paint ball marker useful in identifying those parts that may be permanently lubricated in accordance with the present invention.

### DESCRIPTION OF THE PREFERRED EMBODIMENT

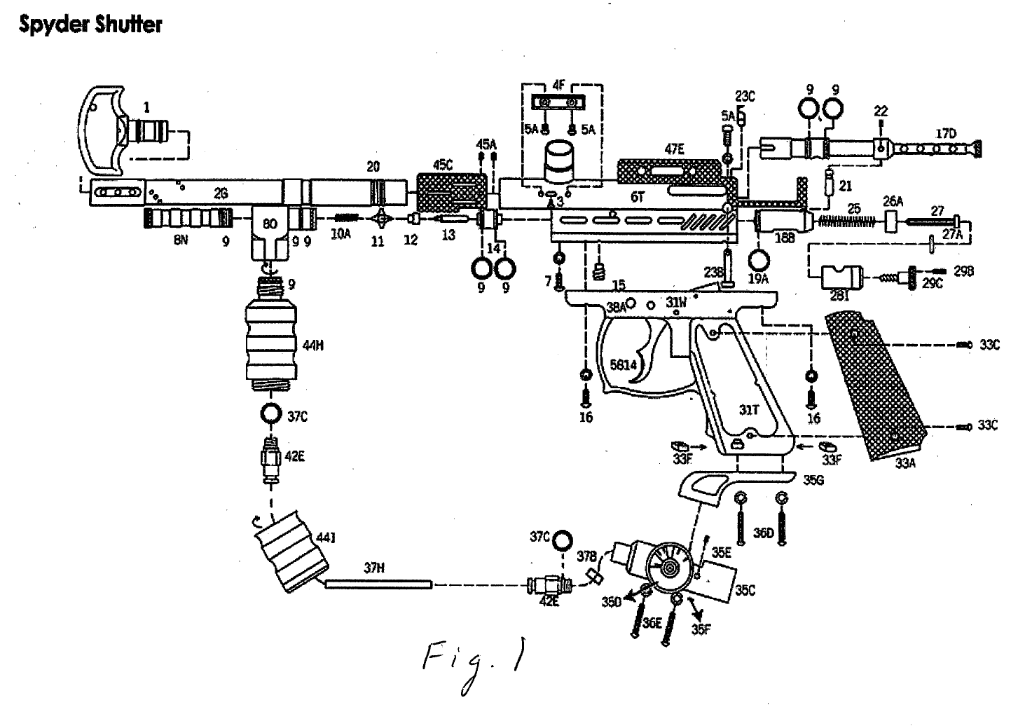

Referring to FIG. 1, there is shown an exploded view of a commercially available paint ball marker which is merely exemplary of any number of such products. The marker of FIG. 1 happens to be a Spyder Java model sold by Kingman International, Inc. of Glendale, Calif. However, it is to be understood that the present invention may be applied to all paint ball markers, irrespective of who the manufacturer thereof may be.

It is preferred that the solid lubrication be applied to those parts experiencing relative motion with another marker part or with the paint ball projectile during operation of the marker. In this regard, the O-rings 9 may comprise a solid lubricious polymer, like Teflon®, or a synthetic elastomer having relatively permanent lubricious properties. The valve spring 10A and the striker spring 25 can be treated, for example, in a thermal spray coating or dipping process with a thin film of suitable coating or plating possessing lubricating properties. Likewise, the cup seal guide 11, the cup seal 12, the valve pin 13, and the valve body 14 are also preferably relatively permanently lubricated using known techniques discussed below. Other parts of the marker of FIG. 1 that will benefit from being relatively permanently lubricated include the rear cocking bolt 17D, the striker 18B, the bolt pin 21, the bolt screw 22, the trigger frame and assembly 31W, and, of course, the barrel 2G, and the receiver 6T.

Lubrication of the above-identified marker parts in the manner described significantly improves the performance of the marker in terms of 1) decreased cycle times, 2) better gas efficiency, 3) a longer parts life, 4) increased accuracy, 5) the marker needs less frequent cleaning, 6) and jamming is reduced. Gas pressures can be lowered because the marker needs less force for it to cycle. Incidences of paint balls rupturing within the marker's barrel are also reduced.

Most paint ball markers are made of aluminum that is so soft that the pressures involved tend to score the moving parts, even with the use of current oil or grease lubrication recommended by the manufacturers. The metal simply scores or sheers off. To alleviate this problem, we first make the marker materials stronger and harder. The solid lubricant is then placed over the harder surface for optimal results. There are several ways in which this task can be accomplished. 1) The first is to make the markers out of harder aluminum and/or other materials such as steel or titanium or magnesium. 2) Hardening of the aluminum is achieved by plating the surface with an extremely strong substance (as described above) and then applying solid lubricant over the hardened part. 3) The aluminum can also be hardened using type three anodizing and then placing the lubricant on top of that surface. The application of type three anodic coating may be preceded by a series of chemical immersions to prepare the surface followed by rinse immersions in plain tap water or de-ionized water. These immersion steps clean and activate the aluminum surface. Once the aluminum surface is clean and free of any residual contaminants, the part is ready for application of the anodic coating.

Protective coatings have been developed for the protection of the marker by their high hardness and chemical inertness. The ecologically questionable galvanic processes (e.g. hard chrome) have been used for over a century to protect steel tools, and many other techniques are known today, such as electroless plating, gas and plasma nitriding etc.

The development of the hard protective coatings in the narrower sense started in the sixties with the chemical (CVD) and physical (PVD) vapor deposition techniques. There are many PVD variants in use today (magnetron sputtering, evaporation by laser, cathode arc, electron beam etc.). Their common feature is the vacuum environment, the substrate temperature is from room temperature up to about 500° C., the coating thickness does not exceed a few micrometers.

The most common hard coatings are based on transition metal nitrides (TiN, CrN), but in the last decade there has been a vast increase in multicomponent coatings (TiAIN), multilayer coatings (TiN/TiAIN) as well as carbon-based coatings (DLC). The newest generation is represented by nanocomposite (TiN+DLC) and lubricating coatings (WC+C).

The most important feature of the hard protective coatings is to reduce wear and in this way to increase the product lifetime. So it is important to know which mechanism has the highest contribution to the wear (abrasion, adhesion, corrosion, high temperature, material sticking etc.) in order to find the most suitable coating for the desired process. A combination of certain coating properties opens possibilities for new technological procedures, e.g. low coefficient of friction and resistance against high temperatures enables dry machining without use of cooling-lubricating liquids. Aside from the price reduction, such a procedure is superior from the ecological standpoint.

This hardening step provides an extra amount of protection for the marker and also increased the markers ability to maintain its tolerances. 4) Fourth, by cryogenically freezing the markers one can increase hardness. This process involves placing a marker or its parts into a nitrogen-cooling chamber. This chamber is filled with nitrogen gas to lower the temp to approximately minus 146 degrees Celsius. Then, liquid nitrogen is then added to drop the temperature to minus 196 degrees Celsius. The marker is left in the liquid nitrogen for approximately 20 hours. At the end the liquid nitrogen is allowed to burn off and the marker returns to room temperature. This process can be repeated numerous times to increase hardness.

Graphite and molybdenum disulfide (MoS2) are the predominant materials used as solid lubricant. In the form of dry powder these materials are effective lubricant additives due to their lamellar structure. The lamellas orient parallel to the surface in the direction of motion.

Even between highly loaded stationary surfaces the lamellar structure is able to prevent contact. In the direction of motion the lamellas easily shear over each other resulting in a low friction. Large particles best perform on relative rough surfaces at low speed, finer particle on relative smooth surface and higher speeds.

Other components that are useful solid lubricants for paint ball markers include boron nitride, polytetrafluorethylene (PTFE), talc, calcium fluoride, cerium fluoride and tungsten disulfide.

Solid lubricants are useful for many conditions when conventional lubricants are inadequate.

A typical application is a sliding or reciprocating motion that requires lubrication to minimize wear as, for example, in valve solenoid plunger lubrication. Liquid lubricants will be squeezed out while solid lubricants don't escape and prevent for fretting corrosion and galling.

Another application of solid lubricants is in cases where chemically active lubricant additives have not been found for a particular surface, such as polymers and ceramics.

Graphite and MoS2 withstand high temperature and oxidizing atmosphere environments, whereas liquid lubricants typically will not survive.

The lamellar structure of graphite and M₂ S₂ orient parallel to the sliding surface resulting in high bearing-load combined with a low shear stress. Most applications in metal forming that involve plastic deformation can benefit from the use of solid lubricants.

Graphite is structurally composed of planes of polycyclic carbon atoms that are hexagonal in orientation. The distance of carbon atoms between planes is longer and therefore the bonding is weaker.

Graphite is best suited for lubrication in a regular atmosphere. Water vapor is a necessary component for graphite lubrication. The adsorption of water reduces the bonding energy between the hexagonal planes of the graphite to a lower level than the adhesion energy between a substrate and the graphite. Because water vapor is a requirement for lubrication, graphite is not effective in vacuum. In an oxidative atmosphere graphite is effective at high temperatures up to 450° C. continuously and can withstand much higher temperature peaks.

Graphite is characterized by two main groups: natural and synthetic. Synthetic graphite is a high temperature sintered product and is characterized by its high purity of carbon (99.5-99.9%). The primary grade synthetic graphite can approach the good lubricity of quality natural graphite.

Natural graphite is derived from mining. The quality of natural graphite varies as a result of the ore quality and post mining processing of the ore. The end product is graphite with a content of carbon (high grade graphite 96-98% carbon), sulfur, SiO2 and ash. The higher the carbon content and the degree of graphitization (high crystalline), the better the lubricity and resistance are to oxidation. For applications where only a minor lubricity is needed and a more thermally insulating coating is required, then amorphous graphite would be chosen (80% carbon).

Molybdenum Disulfide (MoS2) is a mined material found in the thin veins within granite and is highly refined in order to achieve a purity suitable for lubricants. Just like graphite MoS2 has a hexagonal crystal structure with the intrinsic property of easy shear. MoS2 lubrication performance often exceeds that of graphite and is effective in vacuum as well whereas graphite is not. The temperature limitation of MoS2 at 400° C. is restricted by oxidation. The particle size and film thickness are important parameters that should be matched to the surface roughness of the substrate. Large particles may result in excessive wear by abrasion caused by impurities in the MoS2, small particles may result in accelerated oxidation.

Boron Nitride is another solid, ceramic powder lubricant that may be employed as a relatively permanent lubricant for paint ball guns. Boron nitride is available in two chemical structures, i.e. cubic and hexagonal where the last is the lubricating version. The cubic structure is very hard and used as an abrasive and cutting tool component. Thus, the hexagonal variety is preferred for the present application.

PTFE is widely used as an additive in lubricating oils and greases. Due to the low surface energy of PTFE, stable unflocculated dispersions of PTFE in oil or water can be produced. Contrary to the other solid lubricants discussed, PTFE does not have a layered structure. The macro molecules of PTFE slip easily along each other, similar to lamellar structures. PTFE shows one of the smallest coefficients of static and dynamic friction, down to 0.04. Operating temperatures are limited to about 260° C.

For parts that are inaccessible for lubrication after assembly a dry film lubricant can be sprayed. After the solvent evaporates, the coating cures at room temperature to form a solid lubricant.

Anti-friction coatings comprising “lubricating paints” consisting of fine particles of lubricating pigments, such as molydisulfide, PTFE or graphite, blended with a binder may also be used in treating selected parts of the paint ball marker. After application and proper curing, these lubricants bond to the metal surface and form a dark gray solid film. Many dry film lubricants also contain special rust inhibitors, which offer exceptional corrosion protection. Most long-wearing films are of the bonded type but are still restricted to applications where sliding distances are not too long. Antifriction, where operating pressures exceed the load-bearing capacities of ordinary oils and greases, where smooth running in is desired, where clean operation is desired (anti-friction coatings will not collect dirt and debris like greases and oils), where parts may be stored for long periods of time.

Solid lubricants as PTFE, graphite, MoS2 and some other anti friction and anti wear additives are often compounded in polymers and all kind of sintered materials. MoS2 for example is compounded in materials for sleeve bearings, elastomere O-rings, carbon brushes etc. Solid lubricants are compounded in plastics to form a “Self lubricating” or “Internally lubricated” thermoplastic composite. PTFE particles, for example, compounded in the plastic form a PTFE film over the mating surface resulting in a reduction of friction and wear. MoS2 compounded in Nylon reduces wear, friction and stick-slip. Furthermore it acts as a nucleating agent effecting in a very fine crystalline structure.

The plating of suitable metals mainly depends on the physical properties and composition of the metal that is going to be plated. Some may not be good conductors, thereby making poor cathodes for the electroplating process. Others may not plate well because of a strength-weight ratio of the metal to be plated. If the strength to weight ratio is low, then the plating material may not hold well with the metal. If the strength to weight is high, then the plating will hold well to the metal, ensuring a good bond between the two. Ideal metals to plate are: Steel, brass, zinc die castings, coppery alloys (zinc and tin), beryllium and aluminum.

Before a metal is plated, it must go through a process of pretreatment. In the pretreatment, the metal is cleansed and prepared with other chemicals that will quicken or make a more reliable adhesion with the plating metal. A design consideration for this would be to make the object to be plated have certain design characteristic that will make the plating even and stable.

The term “Barrel Plating” is used when the plating is done inside of a perforated barrel, and the barrel is rotated to even the plating. It is mainly used in the plating of small diverse objects, devoid of sharp and long edges that tend to plate badly.

Rack Plating is used for plating objects that are too heavy, too large, or too complicated to barrel plate. These can vary from small things such as keyholes, to large roller. Most rack plating setups are made up of copper rods, that conduct electricity very well, and are very durable. The objects are clipped to this copper rack and then put in to the electrolyte solution. The placement of the copper rack in the solution is crucial because if the rack is placed incorrectly, the plating may be lop-sided and uneven.

Temperature Control is important in most plating solutions. A few such solutions require cooling, others require heating, and some need both. A method of cooling and heating would be to pipe hot or cold water through pipes that go through the solution.

Agitation in plating increases the density and effectiveness of the plating in some cases. An example of this would be to leave a copper plated substance out in the air. This would improve its luster and durability. A good method that agitates would be barrel plating.

Filtration and ventilation come into consideration because there may be a need to remove substances that are contained within the electrolyte. These deposits may ruin the plating, and should be removed at a certain interval of time. This turnover rate should be around twice every hour, depending on what solution one is using. Power supplies are important because certain levels of voltage affect the plating process. A regulated and even current is most ideal. A current that is sporadic or uneven affects the plating process.

Anodes are probably one of the most important things to consider in electro-plating. The anodes work better if they are made up of an alloy that also contains the plating metal. This helps ensure that proper positive ions of the plating metal are conducted through the electrolyte.

Plating can be successfully performed on many plastics, including ABS, polypropylene, polysulfone, modified poly-phenylene oxide, polycarbonate, polyester, and nylon, to provide a hard surface for wear and corrosion resistance. Plating can improve physical properties of the plastics part, such as tensile and flexural strength and the heat deflection temperature. Because of their light weight and ease of design, plastics have been used in many applications replace zinc die castings, brass, and steel.

Since plastics are nonconductive, they must first be processed through a replate cycle during which a metallic coating is deposited by an electroless plating process to make the plastics part conductive. The preplate cycle consists of etching, neutralizing, catalyzing, acceleration, and electroless plating.

The etch bath may consist of a highly concentrated acid solution of chromic and sulfuric acid. The solution oxidizes selective areas on the plastics part. The holes produced by the oxidizing action are absorbing sites that hold small metallic particles that serve as activators for electroless plating. The hole size influences adhesion and other physical properties. After etching, the plastic is thoroughly rinsed.

The neutralizing bath containing mild acids or alkaline solutions chemically neutralize the acids from the etching bath.

In the catalyzing step, a catalytic film is put on the oxidized surface to prepare for electroless metal disposition. It is done in two steps, in step 1 the liquid is immersed in a bath, step 2 involves another solution that prepare the plastic to be plated by nickel or other suitable metals comprising a solid lubricant.

The accelerator bath removes all of the chemical that remains after the catalyzing procedure. It also accelerates the catalyzic film, to ensure a rapid coverage of electroless deposits.

The electroless plating bath is the final bath of the preplate cycle. A thin deposit of metallic film is deposited on the plastics part. It can be made of nickel or copper depending on the objects application. Electroless plating helps electroplated plastics in a corrosive environment.

As those skilled in the art of plastics plating are aware, there are many ways to plate plastics. Some of the following are: Strike bath, acid copper bath, semi bright nickel bath and chromium plating bath.

The process described above should be done in the best of conditions possible. One should rinse the object being plated after every step taken. There should be careful watch over different aspects of each constituent. pH levels, temperature, or brightener level fluctuations may ruin the whole process. A Hull cell may be used to show current ranges, the appearance of the deposit, and to check if there are impurities. If there are any changes in the solution, the Hull cell would detect it.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself

What is claimed is:

1. A method of treating selected parts of paint ball markers, comprising the step of applying a solid lubricant to those surfaces of selected working parts of a paint ball marker that are exposed to relative motion with another working part or with a paint ball projectile.

2. The method of claim 1 and further including a stop of hardening said selected parts before the step of applying said solid lubricant to said surfaces.

3. The method of claim 1 where the selected items of the working parts are coated with a material selected from a class consisting of metals, chemicals, ceramics, elements, graphite and polymers excluding lubricious properties.

4. The method of claim 3 wherein the metals include one of nickel, silver, zinc, copper, molybdenum and alloys thereof.

5. The method of claim 3 wherein the polymers include silicone, ptfe, uhmw polyethylene and other fluoropolymers.

6. The method of claim 1 wherein the solid lubricant comprises a thin film coating incorporating particles selected from a group consisting of molybdenum disulfide, graphite, silicone, carbon and fluoropolymers.

7. The method of claim 1 and further including the steps of:
(a) cleaning said surfaces with one of an alkaline and acid bath to remove any contaminants therefrom;
(b) rinsing said surfaces free of the alkaline or acid bath; and
(c) chemically etching said surface prior to applying the solid lubricant to said surfaces.

8. The method as in claim 6 wherein the surfaces are aluminum and the permanent lubricant is nickel.

9. The method as in claim 7 and further including a step of pretreating the aluminum surfaces with a zincate solution and hard anodizing the surfaces following the chemical etching step and prior to applying the solid lubricant.

10. The process for treating working parts of a paint ball marker comprising hardening mating surfaces of said working parts; and
applying a solid lubricant to said mating surface.

11. The process as in claim 1 wherein one such mating surface comprises moving parts of a solenoid valve.

12. The method of claim 1 wherein said application of the solid lubricant comprises subjecting the selected parts to an aerosol spray.

13. The method of claim 1 wherein said application of the solid lubricant is by one of wicking, wiping, brushing, dipping, coating and immersion.

14. The method of claim 1 wherein said application of solid lubricant is by one of air-less spraying, air-assisted spraying, air brushing, and spray pumping.
